(19) United States
(12) Patent Application Publication
(10) Pub. No.: US 2026/0133400 A1
(43) Pub. Date: May 14, 2026

(54) TELESCOPIC LENS AND ELECTRONIC DEVICE

(71) Applicant: AAC Microtech (Changzhou) Co., Ltd., Changzhou City (CN)

(72) Inventors: Feng Yan, Changzhou (CN); Junsheng Wang, Changzhou (CN)

(21) Appl. No.: 19/193,922

(22) Filed: Apr. 29, 2025

Related U.S. Application Data
(63) Continuation of application No. PCT/CN2024/131626, filed on Nov. 12, 2024.

(51) Int. Cl. G02B 7/10

(52) U.S. Cl. CPC G02B 7/102

(57) ABSTRACT

Provided are a telescopic lens and an electronic device. The telescopic lens includes a base, a stator assembly, a rotor assembly, a lifting member, a protective lens assembly, and a lens assembly. The stator assembly includes an annular stator, a plurality of winding posts, and a plurality of windings. The rotor assembly includes a magnetic annular rotor and an annular connection frame, and the inner peripheral side of the annular connection frame is provided with a track groove. The lifting member is accommodated in the annular connection frame and at least partially slidably assembled in the track groove. Upon energization of the windings, the windings and the annular rotor are used for driving the lifting member to move up and down along the track groove. The telescopic lens features a small size occupation, high transmission efficiency, small backlash error, drop resistance, simple structure and manufacturing process, and high stability.

### TECHNICAL FIELD

The present disclosure relates to the technical field of electronic devices, and in particular, to a telescopic lens and an electronic device.

### BACKGROUND

In order to improve the photo-taking quality, electronic devices, such as mobile phones, have increasingly high requirements for lenses. For example, a telescopic lens is used on an electronic device to achieve zooming. Compared with the telescopic lens on a traditional single-lens reflex camera, disposing the telescopic lens on an electronic device needs to meet the requirement that the electronic device should be relatively thin and light. In the related technologies, the telescopic lens generally uses a micro-step motor, a gear set, a screw rod structure, etc., to realize torque amplification and reverse transmission, so as to achieve the telescoping of the lens. Since this telescoping method adopts multi-stage gear transmission, the gear transmission noise is large, and the backlash is larger, resulting in lower transmission efficiency. Meanwhile, there is a large number of gear structures, resulting in a large overall volume and making it impossible to make the structure lightweight. Moreover, the telescopic lens requires a large number of parts and components, which makes the assembly of the telescopic lens complex and the manufacturing cost higher.

Therefore, it is necessary to provide a new telescopic lens and an electronic device to solve the above-mentioned problems.

### SUMMARY

The technical problems to be solved by the present disclosure are to provide a telescopic lens which features a small size occupation, high transmission efficiency, small backlash error, drop resistance, simple structure and manufacturing process, and high stability.

In order to solve the above-mentioned technical problems, in a first aspect, an embodiment of the present disclosure provides a telescopic lens including a base, a stator assembly fixed to the base, a rotor assembly rotatably connected to the base and accommodated inside the stator assembly, a lifting member connected to the rotor assembly, a protective lens assembly slidably assembled to the base and connected to the lifting member, and a lens assembly connected to the base, the protective lens assembly, or the lifting member,
where the stator assembly includes an annular stator ring fixed to the base, a plurality of winding posts protruding from an inner peripheral side of the stator ring towards the lens assembly, and a plurality of windings respectively sleeved on and fixed to the plurality of winding posts; and the plurality of winding posts are each spaced apart from the rotor assembly; and
the rotor assembly includes a magnetic annular rotor rotatably connected to the base, and an annular connection frame fixed to an inner peripheral side of the annular rotor, the inner peripheral side of the annular connection frame is provided with a track groove, the track groove is disposed obliquely with respect to a circumferential direction of the annular connection frame, the lifting member is accommodated in the annular connection frame, and the lifting member is at least partially slidably assembled in the track groove; and upon energization of the windings, the windings generate a magnetic field interacting with the annular rotor and drive the annular rotor to rotate for driving the lifting member to move up and down along the track groove.

As an improvement, the plurality of winding posts are disposed in an annular array.

As an improvement, the stator ring is an integrally formed structure made of silicon steel material or is formed by stacking a plurality of silicon steel sheets.

As an improvement, the lifting member includes: an annular lifting portion connected to the protective lens assembly, and at least two protruding portions fixed to the annular lifting portion and slidably assembled in the track groove; and the protruding portions are each provided on an outer peripheral side of the annular lifting portion.

As an improvement, the protective lens assembly includes: a mounting base slidably assembled to the base and having two ends communicating with each other to form a first accommodating cavity, and a protective lens fixed to an end of the mounting base away from the base and covering the first accommodating cavity; and the lifting member is accommodated in the first accommodating cavity and is connected to the lens assembly, the mounting base is provided with at least two first relief through-slots extending along a sliding direction thereof from an end of the mounting base close to the base, and the protruding portions pass through the first relief through-slots and are slidably assembled in the track groove.

As an improvement, the mounting base includes: a first sleeve slidably assembled to the base and provided with the first accommodating cavity, an annular bottom plate fixed to one end of the first sleeve away from the protective lens, and an annular top plate fixed to the other end of the first sleeve; and the lifting member is provided between the annular bottom plate and the annular top plate, and the lifting member and the annular top plate form an elastic connection to each other through a buffer assembly; and where when no downward pressure is applied to the protective lens assembly, the lifting member always abuts against the annular bottom plate under the action of an elastic force of the buffer assembly.

As an improvement, the base includes: an annular base body, a support portion formed by extending from an inner peripheral side of the base body towards the direction close to the lens assembly, and a second sleeve formed by bending and extending from the support portion towards the rotor assembly; the second sleeve is provided with a second accommodating cavity, the lens assembly is provided in the second accommodating cavity at intervals, the second sleeve is disposed in and spaced apart from the annular connection frame, the second sleeve is provided with at least two second relief through-slots respectively disposed opposite to the first relief through-slots, and each of the protruding portions sequentially passes through the first relief through-slot and the second relief through-slot correspond thereto, and is slidably assembled in the track groove.

As an improvement, the support portion is provided with a plurality of lead-out holes penetrating through the support portion, and the lead-out wires of the windings are respectively led out through the lead-out holes.

As an improvement, the telescopic lens further includes a dustproof sheet, the dustproof sheet is located at the positions of the lead-out holes and is fixed on a side of the support portion away from the stator assembly in a covering manner.

As an improvement, the telescopic lens further includes an annular protective shell fixed to an end of the base body away from the support portion, and an annular sealing member fixed to the annular protective shell and in sealed contact with the protective lens assembly.

As an improvement, the annular rotor is an integrally-formed annular structure with multi-pole radial magnetization or an annular structure enclosed by a plurality of magnets; where the plurality of magnets are arranged along an outer periphery of the annular connection frame in an alternating manner of N-poles and S-poles.

As an improvement, the telescopic lens further includes a position acquisition unit configured to acquire a rotation parameter of the rotor assembly; and
where the position acquisition unit includes a permanent magnet and a position sensor, the permanent magnet is embedded in a side of the rotor assembly close to the base, the position sensor is fixed to the base, and the permanent magnet and the position sensor are correspondingly disposed and spaced apart from each other.

As an improvement, the telescopic lens further includes a buffer assembly accommodated in the first accommodating cavity, and the buffer assembly includes: a guide member having two ends respectively fixed to the annular bottom plate and the annular top plate and provided along a sliding direction of the mounting base; and an elastic member having two ends respectively connected to the lifting member and the annular top plate; and the guide member passes through the lifting member and is slidably assembled with the lifting member.

In a second aspect, an embodiment of the present disclosure provides an electronic device including the above-described telescopic lens.

Compared with the related technologies, in the telescopic lens of the present disclosure, the stator assembly drives the annular rotor to rotate, and the annular connection frame is driven by the annular rotor to rotate. Since the lifting member is at least partially slidably assembled in the track groove, and the track groove is disposed obliquely with respect to the circumferential direction of the annular connection frame, it is possible for the annular connection frame to drive the lifting member to move up and down. The protective lens assembly slides up and down under the drive of the lifting member, thereby realizing the extension or retraction action of the protective lens assembly. Meanwhile, after the protective lens assembly is extended or before the protective lens assembly is retracted, the lens assembly may be automatically extended or retracted, or the lens assembly can follow the movement of the lifting member or the protective lens assembly, thereby achieving the purpose of optical zoom. Accordingly, through the mutual cooperation among the stator assembly, the annular rotor, the annular connection frame, and the lifting member in the present disclosure, it is possible to omit a gear set, avoiding multi-stage gear transmission loss, with high transmission efficiency, lower power consumption, lower noise, a greatly simplified number of parts and components, easy assembly, and a significant reduction in manufacturing cost. Moreover, due to the direct driving between the stator assembly and the rotor assembly, the backlash error caused by the accumulation of gear transmission clearance can be reduced, and the transmission precision is higher. Further, it has an overall regular circular appearance structure, which is more aesthetically designed and makes the stacking of the whole device easier.

### BRIEF DESCRIPTION OF DRAWINGS

In order to illustrate the technical solutions in the embodiments of the present disclosure more clearly, the accompanying drawings required to be used in the description of embodiments will be briefly described below. Apparently, the accompanying drawings in the following description are merely some embodiments of the present disclosure, and for those of ordinary skill in the art, other accompanying drawings can also be obtained based on these accompanying drawings without any creative efforts.

FIG. 1 is a schematic view of the structure of an electronic device provided by an embodiment of the present disclosure;

FIG. 2 is an exploded view of a part of the structure of the electronic device provided by the embodiment of the present disclosure;

FIG. 3 is an exploded view of a part of the structure of a telescopic lens provided by an embodiment of the present disclosure;

FIG. 4 is a sectional view taken along the line A-A in FIG. 3;

FIG. 5 is a sectional view taken along the line B-B in FIG. 3;

FIG. 6 is a schematic view of the structure of a base of the telescopic lens provided by the embodiment of the present disclosure; and

FIG. 7 is a schematic view of the structure of a stator assembly of the telescopic lens provided by the embodiment of the present disclosure.

### DESCRIPTION OF EMBODIMENTS

The technical solutions in embodiments of the present disclosure will be described clearly and completely below in conjunction with the accompanying drawings in the embodiments of the present disclosure. Apparently, these embodiments described are merely some, but not all, of the embodiments of the present disclosure. Based on the embodiments of the present disclosure, all other embodiments obtained by those of ordinary skill in the art without any creative efforts shall fall within the protection scope of the present disclosure.

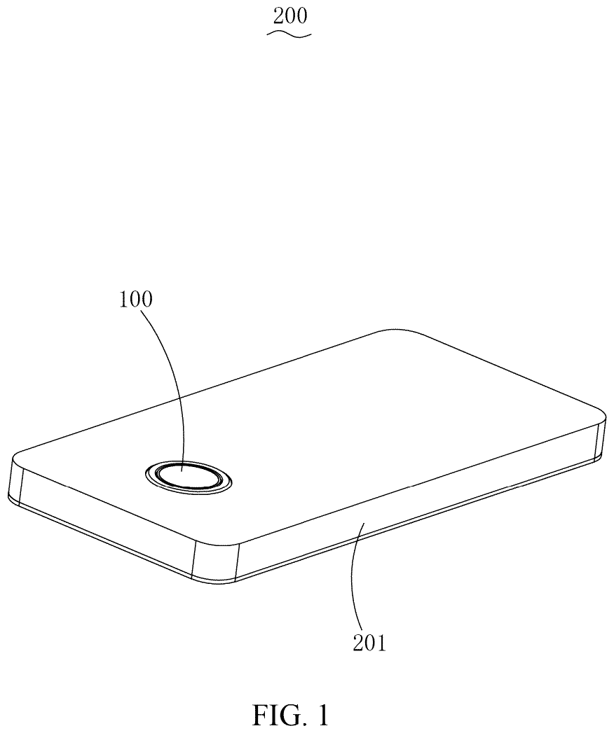

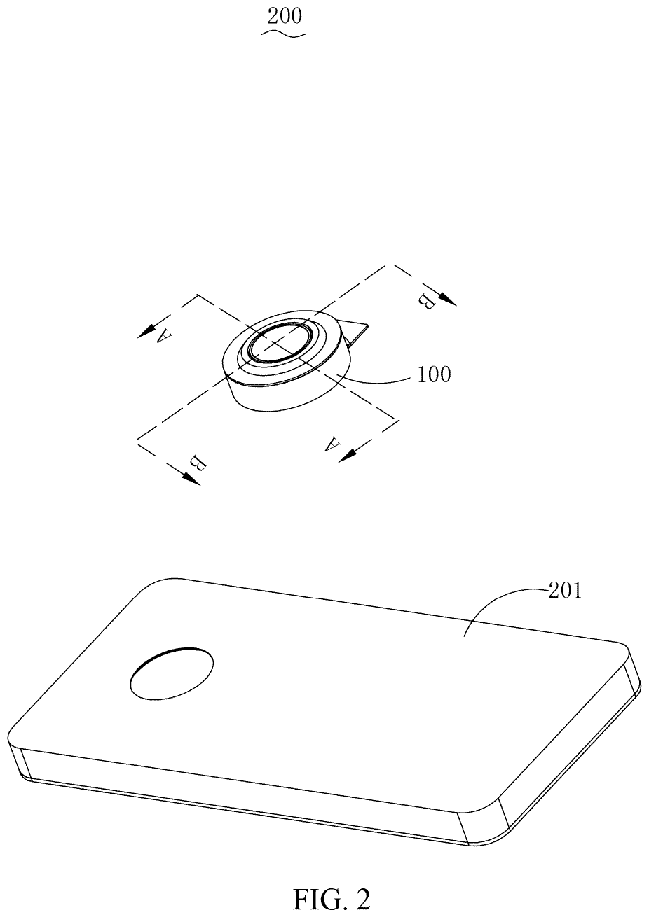

Referring to FIGS. 1-2, an embodiment of the present disclosure provides an electronic device 200 including a device body 201 and a telescopic lens 100 assembled in the device body 201. The electronic device 200 may be a mobile phone or the like. The telescopic lens 100 is a rear lens of the mobile phone. The telescopic lens 100 may realize optical zoom through telescopic motion, so that the mobile phone has a shooting effect similar to that of a single-lens reflex camera.

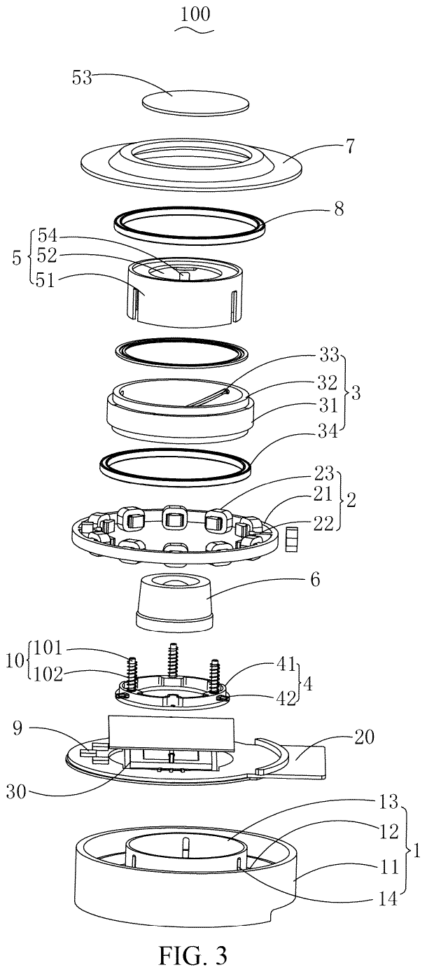

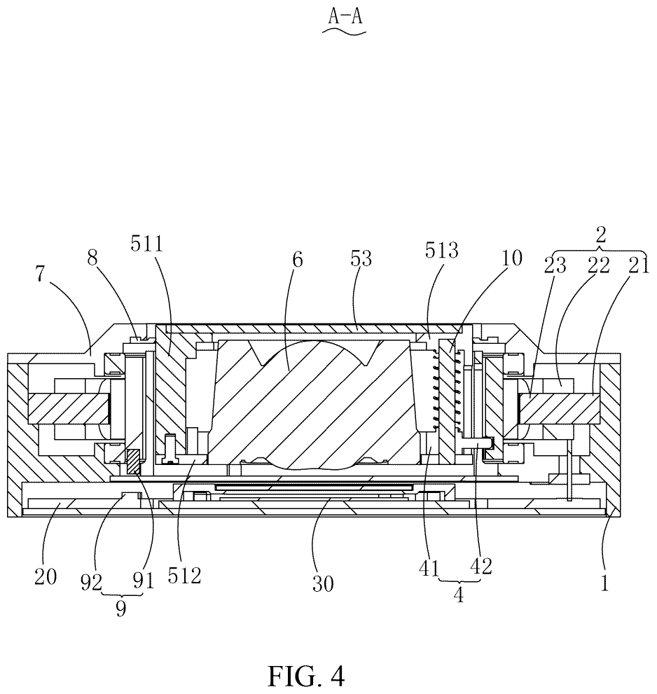

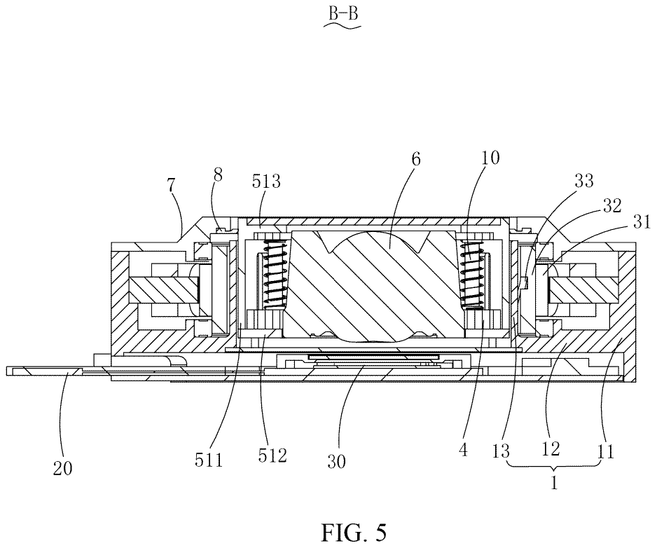

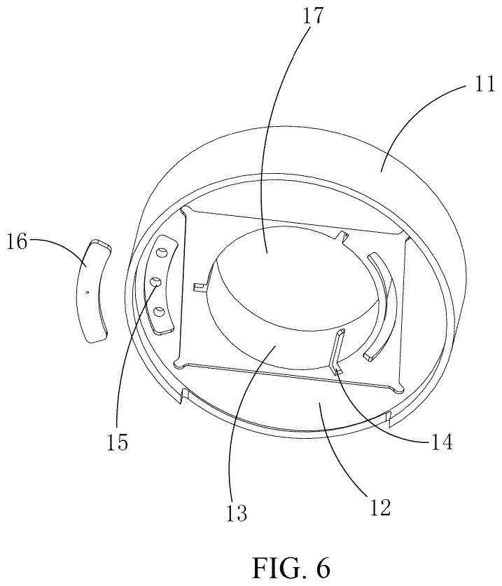

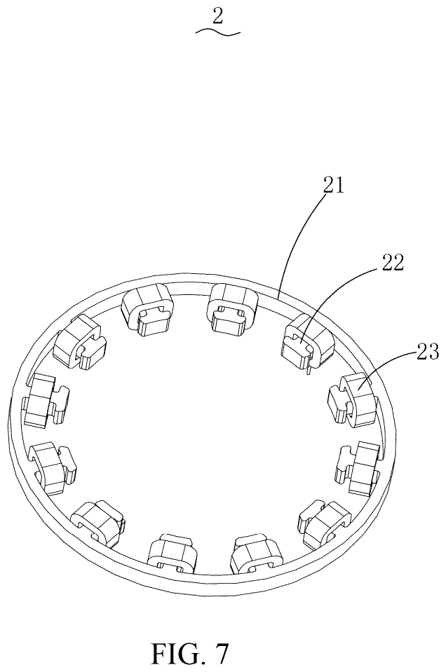

Referring to FIGS. 2-7, the present disclosure provides a telescopic lens 100 including a base 1, a stator assembly 2 fixed to the base 1, a rotor assembly 3 rotatably connected to the base 1 and accommodated inside the stator assembly 2, a lifting member 4 connected to the rotor assembly 3, a protective lens assembly 5 slidably assembled to the base 1 and connected to the lifting member 4, and a lens assembly 6 connected to the base 1, the protective lens assembly 5, or the lifting member 4.

The stator assembly 2 includes an annular stator ring 21 fixed to the base 1, a plurality of winding posts 22 protruding from an inner peripheral side of the stator ring 21 towards the lens assembly 6, and a plurality of windings 23 respectively sleeved on and fixed to the plurality of winding posts 22. The plurality of winding posts 22 are each spaced apart from the rotor assembly 3.

The rotor assembly 3 includes a magnetic annular rotor 31 rotatably connected to the base 1, and an annular connection frame 32 fixed to an inner peripheral side of the annular rotor 31. The inner peripheral side of the annular connection frame 32 is provided with a track groove 33, the track groove 33 is disposed obliquely with respect to a circumferential direction of the annular connection frame 32, the lifting member 4 is accommodated in the annular connection frame 32, and the lifting member 4 is at least partially slidably assembled in the track groove 33. Upon energization of the windings 23, the windings 23 generate a magnetic field interacting with the annular rotor 31 and drive the annular rotor 31 to rotate for driving the lifting member 4 to move up and down along the track groove 33.

In particular, upon energization of the windings 23 of the stator assembly 2, the annular rotor 31 is driven to rotate, the annular connection frame 32 is driven by the annular rotor 31 to undergo a rotational movement. Since the lifting member 4 is at least partially slidably assembled in the track groove 33, and the track groove 33 is disposed obliquely with respect to the circumferential direction of the annular connection frame 32, it is possible for the annular connection frame 32 to drive the lifting member 4 to move up and down. The protective lens assembly 5 slides up and down under the drive of the lifting member 4, thereby realizing the extension or retraction action of the protective lens assembly 5. Meanwhile, after the protective lens assembly 5 is extended or before the protective lens assembly 5 is retracted, the lens assembly 6 may be automatically extended or retracted, or the lens assembly 6 can follow the movement of the lifting member 4 or the protective lens assembly 5, thereby achieving the purpose of optical zoom. Accordingly, through the mutual cooperation among the stator assembly 2, the annular rotor 31, the annular connection frame 32, and the lifting member 4 in the present disclosure, it is possible to omit a gear set, avoiding multi-stage gear transmission loss, with high transmission efficiency, lower power consumption, lower noise, a greatly simplified number of parts and components, easy assembly, and a significant reduction in manufacturing cost. Moreover, due to the direct driving between the stator assembly 2 and the rotor assembly 3, the backlash error caused by the accumulation of gear transmission clearance can be reduced, and the transmission precision is higher.

In this embodiment, the track groove 33 may be disposed obliquely upward or obliquely downward. For example, when the track groove 33 is disposed obliquely upward, if the stator assembly 2 drives the annular rotor 31 to rotate clockwise, then the annular connection frame 32 drives the lifting member 4 to descend; and if the stator assembly 2 drives the annular rotor 31 to rotate counterclockwise, then the annular connection frame 32 drives the lifting member 4 to ascend.

In this embodiment, the plurality of winding posts 22 are disposed in an annular array. As such, the windings 23 on the winding posts 22 are uniformly distributed, and the magnetic field generated upon energization of the windings 23 has good driving stability and sufficient driving power.

In this embodiment, the stator ring 21 is an integrally formed structure made of silicon steel material or is formed by stacking a plurality of silicon steel sheets, thereby achieving high structural strength.

In this embodiment, the lifting member 4 includes an annular lifting portion 41 connected to the protective lens assembly 5, and at least two protruding portions 42 fixed to the annular lifting portion 41 and slidably assembled in the track groove 33. The protruding portions 42 are each provided on an outer peripheral side of the annular lifting portion 41.

When the annular connection frame 32 is rotated, the protruding portions 42 are driven by the annular connection frame 32 to ascend or descend, the annular lifting portion 41 follows the protruding portions 42 to ascend or descend, and meanwhile, the protective lens assembly 5 is driven by the annular lifting portion 41 to ascend or descend, achieving the extension or retraction of the protective lens assembly 5. The protruding portions 42 are adapted to the track groove 33, and the protruding portions 42 are cylindrical, which is conducive to the sliding of the protruding portions 42 in the track groove 33. The annular connection frame 32 is provided with a bottom end and a top end that are distributed at intervals in a sliding direction of the protective lens assembly 5. One end of the track groove 33 extends to the bottom end of the annular connection frame 32 close to the base to form an opening, which facilitates the assembly of the protruding portions 42 of the lifting member 4 into the track groove 33. The other end of the track groove 33 extends between the bottom end and the top end of the annular connection frame 32 to prevent the protruding portions 42 from sliding out of the track groove 33.

According to actual needs, the protruding portions 42 can be integrally connected with the annular lifting portion 41 or disposed separately from the annular lifting portion 41. The annular connection frame 32 may be provided with a plurality of track grooves 33. The plurality of track grooves 33 are designed in a centrally symmetric manner. When the number of the track grooves 33 is three or more, the track grooves 33 are evenly distributed at equal angles. The outer peripheral side of the annular lifting portion 41 may be provided with a plurality of protruding portions 42, and the plurality of protruding portions 42 are slidably assembled in the plurality of track grooves 33 in one-to-one correspondence. For example, in a specific example, the annular connection frame 32 is provided with three track grooves 33 that are spaced apart from each other and evenly distributed, the outer peripheral side of the annular lifting portion 41 is provided with three protruding portions 42 that are spaced apart from each other and evenly distributed, and the three protruding portions 42 are slidably assembled in the three track grooves 33 in a one-to-one correspondence, which can ensure the stability and smoothness in the annular connection frame 32 driving the lifting member 4 to ascend or descend.

In this embodiment, the annular connection frame 32 can be made of a magnetically conductive material, which can enhance the magnetic performance of the rotor assembly 3 and improve the driving force of the rotor assembly 3. The annular connection frame 32 can be rotatably disposed on the base 1 through a bearing. Alternatively, a transmission track 34 may be disposed on the outer peripheral side of each of the two ends of the annular connection frame 32. The transmission track 34 is provided with balls, and the balls are in contact with the base 1, so that the annular connection frame 32 is rotatably disposed on the base 1.

In some embodiments, the lens assembly 6 is connected to the lifting member 4. The lens assembly 6 includes a lens, the lens assembly 6 is fixed to the annular lifting portion 41 and is accommodated in the annular lifting portion 41, and the lens assembly 6 is driven by the annular lifting portion 41 to move up or down.

In this embodiment, the protective lens assembly 5 includes a mounting base 51 slidably assembled to the base 1 and having two ends communicating with each other to form a first accommodating cavity 52, and a protective lens 53 fixed to an end of the mounting base 51 away from the base 1 and covering the first accommodating cavity 52. The lifting member 4 is accommodated in the first accommodating cavity 52 and is connected to the lens assembly 6, the mounting base 51 is provided with at least two first relief through-slots 54 extending along a sliding direction thereof from an end of the mounting base 51 close to the base 1, and the protruding portions 42 at least partially pass through the first relief through-slots 54 and are slidably assembled in the track groove 33. The lifting member 4 drives the mounting base 51 to move up and down, thereby realizing the extension or retraction action of the protective lens assembly 5. As the protruding portions 42 pass through the first relief through-slots 54, and the lengths of the first relief through-slots 54 are greater than the maximum ascending or descending distance of the lifting member 4, the mounting base 51 will not interfere with the sliding action of the protruding portions 42.

In this embodiment, the mounting base 51 includes a first sleeve 511 slidably assembled to the base 1 and provided with the first accommodating cavity 52, an annular bottom plate 512 fixed to one end of the first sleeve 511 away from the protective lens 53, and an annular top plate 513 fixed to the other end of the first sleeve 511. The lifting member 4 is provided between the annular bottom plate 512 and the annular top plate 513, and the lifting member 4 and the annular top plate 513 form an elastic connection to each other through a buffer assembly 10. When no downward pressure is applied to the protective lens assembly 5, the lifting member 4 always abuts against the annular bottom plate 512 under the action of an elastic force of the buffer assembly 10. As when no downward pressure is applied to the protective lens assembly 5, the lifting member 4 always abuts against the annular bottom plate 512 under the action of the elastic force, and at this time, the lifting member 4 and the mounting base 51 are closely attached to each other, whereby the lifting member 4 and the mounting base 51 can be regarded as a whole, ensuring that the lifting member 4 and the mounting base 51 ascend or descend synchronously.

In this embodiment, the telescopic lens 100 further includes an image receiving assembly 30 fixed to the base 1. The image receiving assembly 30 is disposed directly opposite to the lens assembly 6. When the protective lens assembly 5 extends, the lens assembly 6 moves towards a direction away from the image receiving assembly 30, to change the distance between the lens assembly 6 and the image receiving assembly 30, thereby achieving the purpose of optical zoom.

In this embodiment, the base 1 includes an annular base body 11, a support portion 12 formed by extending from an inner peripheral side of the base body 11 towards the direction close to the lens assembly 6, and a second sleeve 13 formed by bending and extending from the support portion 12 towards the rotor assembly 3. The second sleeve 13 is provided with a second accommodating cavity 17, the lens assembly 6 is provided in the second accommodating cavity 17 at intervals, the second sleeve 13 is disposed in and spaced apart from the annular connection frame 32, the second sleeve 13 is provided with at least two second relief through-slots 14 respectively disposed opposite to the first relief through-slots 54, and each of the protruding portions sequentially passes through the first relief through-slot 54 and the second relief through-slot 14 correspond thereto, and is slidably assembled in the track groove 33. The base body 11, the support portion 12, and the second sleeve 13 may be of an integrated structure and have high structural strength. A gap is provided between the second sleeve 13 and the annular connection frame 32 to ensure the smooth rotation of the annular connection frame 32. Through the correspondence of the second relief through-slots 14 and the first relief through-slots 54, it is possible to avoid the base 1 from interfering with the sliding of the lifting member 4, thereby facilitating the ascending or descending of the lifting member 4.

In some embodiments, the lens assembly 6 is connected to the base 1. The lens assembly 6 includes a lens and a voice coil motor (VCM). The VCM is fixed on the base 1 through the image receiving assembly 30, and the ascending or descending of the protective lens assembly 5 can provide space for the movement of the lens. For example, after the protective lens 53 extends, the VCM drives the lens to move upward to extend; before the protective lens 53 retracts, the VCM drives the lens to move downward to retract.

In this embodiment, the support portion 12 is provided with a plurality of lead-out holes 15 penetrating through the support portion 12, and the lead-out wires of the windings 23 are respectively led out through the plurality of lead-out holes 15 to facilitate connecting them to an external power supply to realize power supply.

In this embodiment, the telescopic lens 100 further includes a dustproof sheet 16. The dustproof sheet 16 is located at the positions of the lead-out holes 15 and is fixed on a side of the support portion 12 away from the stator assembly 2 in a covering manner. Both the lead-out positions and the dustproof sheet 16 (IR sheet) are glued to the base 1, and the stator assembly 2 is completely isolated from a photosensitive module at the bottom, thereby avoiding the risk of generating dust during long-term work. In this embodiment, the telescopic lens 100 further includes an annular protective shell 7 fixed to an end of the base body 11 away from the support portion 12, and an annular sealing member 8 fixed to the annular protective shell 7 and in sealed contact with the protective lens assembly 5. The annular protective shell 7 may decorate the telescopic lens 100, the annular sealing member 8 may be a sealing ring, and the annular sealing member 8 is in sealed contact with an outer peripheral surface of the base body 11, so that the annular sealing member 8 can prevent dust and water, thereby ensuring the sealing performance of the telescopic lens 100.

In this embodiment, the annular rotor 31 is an integrally-formed annular structure with multi-pole radial magnetization or an annular structure enclosed by a plurality of magnets. The plurality of magnets are arranged along an outer periphery of the annular connection frame 32 in an alternating manner of N-poles and S-poles. The magnets are magnetized in a multi-pole radial manner, which is conducive to outputting reluctance torque. The magnets can be prepared using molding techniques such as hot pressing and sintering and have good magnetic performance.

Optionally, the rotor is composed of a plurality of magnets. The number of slots and the number of magnetic poles of the rotor are not specifically limited in actual implementation, and can be designed according to the required parameters and dimensions.

In this embodiment, the telescopic lens 100 further includes a position acquisition unit 9 configured to acquire a rotation parameter of the rotor assembly 3. The position acquisition unit 9 includes a permanent magnet 91 and a position sensor 92. The permanent magnet 91 is embedded in a side of the rotor assembly 3 close to the base 1, the position sensor 92 is fixed to the base 1, and the permanent magnet 91 and the position sensor 92 are correspondingly disposed and spaced apart from each other. The permanent magnet 91 is embedded in a side of the annular connection frame 32 close to the base 1. The position sensor 92 may be a sensor such as a TMR (Tunnel Magnetoresistance)/Hall sensor, to enable detection of the ascending and descending height in real time in the ascending and descending process and implement a closed-loop control.

In this embodiment, the telescopic lens 100 further includes a circuit board 20 fixed to the base 1, and the image receiving assembly 30 is electrically connected to the circuit board 20. The position sensor 92 is fixed on the circuit board 20 and forms an electrical connection with the circuit board 20. The circuit board 20 is a flexible printed circuit (FPC) 20, and has the characteristics of high wiring density, light weight, thin thickness and good bendability.

In this embodiment, the buffer assembly 10 is configured to buffer the movement caused by the downward pressure it receives. The buffer assembly 10 includes a guide member 101 having two ends respectively fixed to the annular bottom plate 512 and the annular top plate 513 and having a length provided along a sliding direction of the mounting base 51, and an elastic member 102 having two ends respectively connected to the lifting member 4 and the annular top plate 513. The guide member 101 passes through the lifting member 4 and is slidably assembled with the lifting member 4. When the protective lens assembly 5 is in an extended state and is pressed downward, the mounting base 51 may move downward and compress the elastic member 102. At this time, the elastic member 102 may be further compressed first, so that the position of the lifting member 4 remains unchanged, avoiding the stress from being directly transmitted to the protruding portions 42 of the lifting member 4 and the annular connection frame 32, thereby protecting the mechanism.

The elastic member 102 is always in a compressed state, so that when no downward pressure is applied to the protective assembly, it can be ensured that the lifting member 4 always abuts against the annular bottom plate 512 under the action of the resilience force provided by the elastic member 102.

According to actual needs, the guide member 101 can be a guide rod, and the elastic member 102 can be a spring. The elastic member 102 can be sleeved on an outer peripheral side of the guide member 101. The number of the guide members 101 and elastic members 102 is set to be the same as that of the protruding portions 42. For example, there are three guide members 101, three elastic members 102, and three protruding portions 42.

Compared with the related technologies, in the telescopic lens of the present disclosure, the stator assembly drives the annular rotor to rotate, and the annular connection frame is driven by the annular rotor to rotate. Since the lifting member is at least partially slidably assembled in the track groove, and the track groove is disposed obliquely with respect to the circumferential direction of the annular connection frame, it is possible for the annular connection frame to drive the lifting member to move up and down. The protective lens assembly slides up and down under the drive of the lifting member, thereby realizing the extension or retraction action of the protective lens assembly. Meanwhile, after the protective lens assembly is extended or before the protective lens assembly is retracted, the lens assembly may be automatically extended or retracted, or the lens assembly can follow the movement of the lifting member or the protective lens assembly, thereby achieving the purpose of optical zoom. Accordingly, through the mutual cooperation among the stator assembly, the annular rotor, the annular connection frame, and the lifting member in the present disclosure, it is possible to omit a gear set, avoiding multi-stage gear transmission loss, with high transmission efficiency, lower power consumption, lower noise, a greatly simplified number of parts and components, easy assembly, and a significant reduction in manufacturing cost. Moreover, due to the direct driving between the stator assembly and the rotor assembly, the backlash error caused by the accumulation of gear transmission clearance can be reduced, and the transmission precision is higher.

The above are merely the embodiments of the present disclosure. It should be noted here that for those of ordinary skill in the art, improvements can be made without departing from the inventive concept of the present disclosure, but all of these fall within the protection scope of the present disclosure.

What is claimed is:

1. A telescopic lens, comprising: a base, a stator assembly fixed to the base, a rotor assembly rotatably connected to the base and accommodated inside the stator assembly, a lifting member connected to the rotor assembly, a protective lens assembly slidably assembled to the base and connected to the lifting member, and a lens assembly connected to the base, the protective lens assembly, or the lifting member,
wherein the stator assembly comprises an annular stator ring fixed to the base, a plurality of winding posts protruding from an inner peripheral side of the stator ring towards the lens assembly, and a plurality of windings respectively sleeved on and fixed to the plurality of winding posts; and the plurality of winding posts are each spaced apart from the rotor assembly; and
the rotor assembly comprises a magnetic annular rotor rotatably connected to the base, and an annular connection frame fixed to an inner peripheral side of the annular rotor, the inner peripheral side of the annular connection frame is provided with a track groove, the track groove is disposed obliquely with respect to a circumferential direction of the annular connection frame, the lifting member is accommodated in the annular connection frame, and the lifting member is at least partially slidably assembled in the track groove; and upon energization of the windings, the windings generate a magnetic field interacting with the annular rotor and drive the annular rotor to rotate for driving the lifting member to move up and down along the track groove.

2. The telescopic lens as described in claim 1, wherein the plurality of winding posts are disposed in an annular array.

3. The telescopic lens as described in claim 1, wherein the stator ring is an integrally formed structure made of silicon steel material or is formed by stacking a plurality of silicon steel sheets.

4. The telescopic lens as described in claim 1, wherein the lifting member comprises: an annular lifting portion connected to the protective lens assembly, and at least two protruding portions fixed to the annular lifting portion and slidably assembled in the track groove; and the protruding portions are each provided on an outer peripheral side of the annular lifting portion.

5. The telescopic lens as described in claim 4, wherein the protective lens assembly comprises: a mounting base slidably assembled to the base and having two ends communicating with each other to form a first accommodating cavity, and a protective lens fixed to an end of the mounting base away from the base and covering the first accommodating cavity; and the lifting member is accommodated in the first accommodating cavity and is connected to the lens assembly, the mounting base is provided with at least two first relief through-slots extending along a sliding direction thereof from an end of the mounting base close to the base, and the protruding portions pass through the first relief through-slots and are slidably assembled in the track groove.

6. The telescopic lens as described in claim 5, wherein the mounting base comprises: a first sleeve slidably assembled to the base and provided with the first accommodating cavity, an annular bottom plate fixed to one end of the first sleeve away from the protective lens, and an annular top plate fixed to the other end of the first sleeve; and the lifting member is provided between the annular bottom plate and the annular top plate, and the lifting member and the annular top plate form an elastic connection to each other through a buffer assembly; and wherein when no downward pressure is applied to the protective lens assembly, the lifting member always abuts against the annular bottom plate under the action of an elastic force of the buffer assembly.

7. The telescopic lens as described in claim 5, wherein the base comprises: an annular base body, a support portion formed by extending from an inner peripheral side of the base body towards the lens assembly, and a second sleeve formed by bending and extending from the support portion towards the rotor assembly; the second sleeve is provided with a second accommodating cavity, the lens assembly is provided in the second accommodating cavity at intervals, the second sleeve is disposed in and spaced apart from the annular connection frame, the second sleeve is provided with at least two second relief through-slots respectively disposed opposite to the first relief through-slots, and each of the protruding portions sequentially passes through the first relief through-slot and the second relief through-slot correspond thereto, and is slidably assembled in the track groove.

8. The telescopic lens as described in claim 7, wherein the support portion is provided with a plurality of lead-out holes penetrating through the support portion, and the lead-out wires of the windings are respectively led out through the lead-out holes.

9. The telescopic lens as described in claim 8, wherein the telescopic lens further comprises a dustproof sheet, the dustproof sheet is located at the positions of the lead-out holes and is fixed on a side of the support portion away from the stator assembly in a covering manner.

10. The telescopic lens as described in claim 9, wherein the telescopic lens further comprises an annular protective shell fixed to an end of the base body away from the support portion, and an annular sealing member fixed to the annular protective shell and in sealed contact with the protective lens assembly.

11. The telescopic lens as described in claim 1, wherein the annular rotor is an integrally-formed annular structure with multi-pole radial magnetization or an annular structure enclosed by a plurality of magnets; wherein the plurality of magnets are arranged along an outer periphery of the annular connection frame in an alternating manner of N-poles and S-poles.

12. The telescopic lens as described in claim 1, wherein the telescopic lens further comprises a position acquisition unit configured to acquire a rotation parameter of the rotor assembly; and
wherein the position acquisition unit comprises a permanent magnet and a position sensor, the permanent magnet is embedded in a side of the rotor assembly close to the base, the position sensor is fixed to the base, and the permanent magnet and the position sensor are correspondingly disposed and spaced apart from each other.

13. The telescopic lens as described in claim 6, wherein the buffer assembly comprises: a guide member having two ends respectively fixed to the annular bottom plate and the annular top plate and provided along a sliding direction of the mounting base; and an elastic member having two ends respectively connected to the lifting member and the annular top plate; and the guide member passes through the lifting member and is slidably assembled with the lifting member.

14. An electronic device, comprising a telescopic lens as described in of claim 1.
